(19) United States
(12) Patent Application Publication
(10) Pub. No.: US 2007/0033446 A1
(43) Pub. Date: Feb. 8, 2007

(54) Monitoring apparatus

(76) Inventors: Paul Tinkler, Bristol (GB); Alexander Dick, Bath (GB); Niall Buckingham, Bath (GB)

Correspondence Address: GIFFORD, KRASS, GROH, SPRINKLE & CITKOWSKI, P.C, PO BOX 7021, TROY, MI, 48007-7021, US

(21) Appl. No.: 11/282,921

(22) Filed: Nov. 18, 2005

(30) Foreign Application Priority Data
Aug. 7, 2005 (GB) 0514133.8

(51) Int. Cl. G06F 11/00

(52) U.S. Cl. 714/47

(57) ABSTRACT

An apparatus for monitoring a digital television decoder connected to a network comprising a monitor engine and a monitor server wherein the monitor engine is operable to receive and/or retrieve raw event data from a digital television decoder connected to a network, generate significant event data in dependence on the received raw event data and in dependence on a set of predetermined rules, and transmit the significant event data to the monitor server which is operable to receive the significant event data from the monitor engine and store the significant event data, the monitor server being operable to retrieve the significant event data on request. Also provided is a method of monitoring a digital television decoder connected to a network comprising the steps of a. receiving and/or retrieving raw event data from a digital television decoder connected to a network; b. generating significant event data in dependence on received raw event data and in dependence on a set of predetermined rules; and c. storing the significant event data.

The present invention relates to monitoring and managing tool for digital receiving equipment connected to a network, and in particular for monitoring and managing a digital television network.

The use of digital signals has become increasingly popular as a means of transmitting information, such as television broadcast signals and the like. Recent developments in digital signal transmission have resulted in more spectrum efficient transmission and compression technologies providing increased interface robustness and higher picture quality using less band width.

With this increase in the capabilities of digital signal transmission and the increased usage of the technology, more and more organisations and individuals are making use of the benefits provided by such technology. For example, the popularity of digital receiving equipment such as set-top boxes (STBs) or digital decoders for receiving television broadcasts and the like has soared. However, once the digital receiving equipment is in place, the user cannot be sure whether any interruption in the digitally broadcast service is due to broadcasting disruption or is, in fact, due to malfunctioning of the digital receiving equipment. This is a situation which is frustrating for the user of the digital receiving equipment and, if it is finally determined that the fault lies with the digital receiving equipment, there will have been an inevitable delay in diagnosis of the problem and thus a consequential delay in reporting the fault and having an engineer attend to repairs.

There are digital broadcasting providers who have in-house systems which can provide feedback to the provider on a limited reactive query basis. However, the limitations of this function prevent continuous polling of information from the digital receiving equipment. In addition, the current monitoring systems do not integrate with other head-end components and are thus of extremely limited value as the limited data that is collected cannot be integrated into a monitoring system and thus be stored, configured or analysed. Thus, the data is merely providing simple information relating to, for example, logging of STB characteristics, including, but not limited to, failures, memory capacity and the like, and is of very little if any use in compiling usable data which could assist in developing a more complete picture of the operation of the digital receiving equipment by a user and, for example, providing detailed information pre and post interruption of the digital broadcast whether due to digital broadcast interruption or digital receiver failure.

The prior art has several disadvantages, such as restricted reactivity and continuity. For example, data is sent from the monitored unit to the controller only once, and then only when requested; this usually happens when there has been a problem reported by the end user.

In addition, the prior art has configurability limitations in that the data sent from the monitored decoder unit is fixed in scope and detail. Furthermore, in the prior art only the last set of received data is typically stored.

There are also limitations with respect to incoming data filtering in the prior art. There is no visual representation of the set of monitored decoder units, or the ability to configure these units into subgroups or to filter the data being reported and viewed live according to the monitored unit or subgroup.

Data analysis is another aspect where prior art limitations restrict the use of the collected data. This is due to a lack of historical data set or aggregate analysis capability.

There is therefore a need for means to allow more comprehensive monitoring of digital receiving equipment connected to a network to allow the subsequently collected information to be used, for example, for diagnostic and analytical purposes.

The present invention seeks to address these problems of the prior art.

The present invention is based upon, and designed around, extensive knowledge of:
a) the capabilities of the monitored units;
b) broadcast and multimedia services;
c) issues arising from monitoring of data, e.g. cases where monitoring affects the performance of the unit;
d) communications protocols;
e) user interfaces; and
f) database design.

Using this knowledge, and an extensive understanding of the shortcomings of the prior art, the system comprising the present invention was decomposed into the separate components (monitored decoder unit, monitor engine, monitor server, monitor client).

In an embodiment of the present invention data may be sent from the monitored unit on a continuous and/or periodic basis.

In an embodiment of the present invention the monitor engine may search and report on infinite combinations of events, timings and internal states. These combinations may be controlled externally, without physical access to the monitored unit, thus allowing far more intelligent monitoring. The assessment of the monitored unit can thus be varied in depth and breadth according to the needs of different clients operating remotely. Furthermore, in contrast to the prior art, in and embodiment of the present invention monitored data may be stored on a continuous basis.

In addition, the disadvantage of the prior art shortcomings with respect to visual representation of the set of monitored decoder units is addressed, as in one embodiment of the present invention, configuration of these units into subgroups and filtering of the data being reported and viewed live according to the monitored unit or subgroup may be carried out.

In one embodiment of the present invention monitored data may be presented in an individual, and/or aggregate and/or historical fashion, and/or in a variety of graphical formats and reports.

A first aspect of the present invention provides an apparatus for monitoring a digital television decoder connected to a network comprising a monitor engine and a monitor server wherein the monitor engine is operable to receive raw event data from a digital television decoder connected to a network, generate significant event data in dependence on the received raw event data and in dependence on a set of predetermined rules, and transmit the significant event data to the monitor server which is operable to receive the significant event data from the monitor engine and store the significant event data, the monitor server being operable to retrieve the significant event data on request.

A further aspect aspect of the present invention provides an apparatus for monitoring a digital television decoder connected to a network comprising a monitor engine and a monitor server wherein the monitor engine is operable to retrieve raw event data from a digital television decoder connected to a network, generate significant event data in dependence on the received raw event data and in dependence on a set of predetermined rules, and transmit the significant event data to the monitor server which is operable to receive the significant event data from the monitor engine and store the significant event data, the monitor server being operable to retrieve the significant event data on request.

A further aspect of the present invention provides an apparatus for monitoring a digital television decoder connected to a network comprising a monitor engine and a monitor server wherein the monitor engine is operable to receive and retrieve raw event data from a digital television decoder connected to a network, generate significant event data in dependence on the received raw event data and in dependence on a set of predetermined rules, and transmit the significant event data to the monitor server which is operable to receive the significant event data from the monitor engine and store the significant event data, the monitor server being operable to retrieve the significant event data on request.

Monitoring apparatus according to the present invention allows the remote assessment of network deployed digital television decoders. The digital television decoders are instrumented to provide raw event data to a Monitor Engine. The Monitor Engine may be co-hosted with each digital television decoder or may communicate with each decoder over a communications link which may be wired (e.g. RS232, ethernet) or wireless (e.g. GSM, GPRS).

The term ‘digital television decoder’ is intended to encompass all devices operable to receive an incoming digital television signal and which are capable of two-way communication and which have been instrumented to provide details of raw events.

The term ‘raw events’ is intended to encompass, but is not limited to, events such as user key presses, error conditions, internal decoder changes, any interactions on the network, and the like. These individual raw events provide the basic data which is sent on to the monitor engine for first line analysis.

The raw events may be reported to a logging component on the digital television decoder. In one embodiment this is done on a triggered or polled basis.

In one embodiment, the set of raw event data that is actively logged may be remotely configured from the monitor server via the monitor engine.

It is preferred that the raw event data is then written to local storage before being flushed to the monitor engine communications link and transmitted to the monitor engine. By operating in such a manner, the digital television decoder is operating as a data logger and behaves in a very similar manner to a standard digital receiver.

Buffering of the raw event data may occur such that raw event data is collected in real time and transmitted to the monitor engine at predetermined intervals, such as predetermined time intervals, or may be transmitted to the monitor engine immediately on occurrence of a specified raw event. It will be appreciated that any predetermined time interval or other parameter used to determine when raw event data is transmitted to the monitor engine may be specified as a default setting of the apparatus or decoder. It will also be appreciated that any such default settings may be re-configured at any time, as desired, either locally or remotely.

The monitor engine retrieves the raw event data from the digital television decoder and performs the basic translation of raw event data into significant event data.

The monitor engine may be further operable to automatically retrieve the raw event data from a digital television decoder connected to a network.

In one embodiment, the monitor engine is operable to retrieve raw event data from a digital television decoder connected to a network at predetermined time intervals.

Significant event data is generally determined from one or more raw events and is generated according to certain predetermined rules which model a predetermined behaviour of the underlying digital television decoder. The behaviour which is modelled includes timing, state transitions and the like of the underlying digital television decoder.

The rules used to generate the significant event data from the raw event data may be configurable, and may be viewed and edited from the monitor server. The rules information may be resident on the monitor engine and/or may be updated via messaging from the monitor server as desired.

The significant event data may be transmitted onwards from the monitor engine to the monitor server on generation, or may be stored on command, or may be stored automatically at predetermined intervals.

Once significant event data is supplied to the monitor server, the monitor server may be further operable to analyse the stored significant event data. Data sent from the monitor engine to the monitor server may include significant event report messages, which may include the event type, descriptive values, time-stamp and digital television decoder identification and operation details. For diagnostic analysis on the monitor server itself, the details of the raw event data leading up the significant event in question may also be sent. This allows a more thorough investigation into the potential causes of the significant event in question and the subsequent events resulting from the significant event in question.

The significant event data is sent by the Monitor Engine(s) to the Monitor Server over a second communications link which is typically wired (e.g. using Internet Protocol (IP) communications) but may also be wireless; alternatively some configurations can have the Monitor Engine and Monitor Server co-hosted. The Monitor Server provides comparative analysis of equipment over time or location, or against other monitored or reference installations. Thus the monitor server may send the monitor engine ‘monitor engine configuration’ messages which update the monitor engine behaviour rules. For example, a monitor engine configuration message may be sent to change a threshold value. In this manner, the monitoring of individual or groups of digital television encoders may be set to provide tailored information in terms of focus and/or depth. For example, one set may be configured for user-oriented information, whereas another set may be configured to provide a more in-depth analysis of a particular problem.

Configuration for a particular purpose involves using the monitor engine rules to focus raw event data retrieval and subsequent reporting on the specific significant events and transmission of specific significant event data that are of interest. In some circumstances and often depending on the significant event of interest, a large list of the raw events, and thus associated raw event data, that led up to the significant event of interest may be of use in analysis, whereas under other circumstances the raw event, and thus raw event data, may be of no interest.

The monitor server may also send digital television decoder configuration messages to the monitor engine which are then transmitted by the monitor engine to the digital television decoder. Such digital television decoder configuration messages define the set of instrumentation points that are switched on i.e. actively logged, within the digital television decoder.

Thus the monitor server is the central server responsible for viewing and controlling both the configuration and the operation of the monitoring apparatus according to the present invention.

For example, the monitor server may be responsible for storing and retrieving significant event data to a database or other suitable storage device. In addition the monitor server may provide an interface to any other network components. The monitor server may also be used to receive comparison data from other networks. In this way, a set of comprehensive information relating to the operation and state of the digital television decoder can be obtained for diagnostic or analytical or recording purposes.

The apparatus may further comprise one or more monitor clients, such as a personal computer (PC), or by cellular phone or personal digital assistant (PDA) or any other suitable device known to the skilled person which is capable of interfacing with the monitor server and accessing the facilities of the monitor server to make use of the data.

The monitor server is also intended to provide the following facilities to monitor clients:
Access Administration i.e. controlling access to the system according to defined roles or capabilities (e.g. network engineer, administrator);
Creating Filter rules i.e. which allow incoming event data to be viewed according to various selective criteria, for example, digital television decoder type etc;
Live update, for example in the form of a display of significant events, filtered according to the above predetermined rules or criteria;
Periodic reporting to file, for example, to provide weekly summary information for managers;
Configuration of the predetermined event modeling rules used to convert raw events into significant events
Remote configuration of the behaviour of the monitor engine, for example, for raw event to significant event translation, digital television decoder state modeling etc.;
Remote configuration of digital television decoder logging (via associated monitor engine); and
Key Performance Indicator (metric) generation from stored data i.e. to provide diagnostic support and derivative statistics providing comparative and trend data, for example, the average time taken to change television channels over a three month period, or the average number of occurrences of video loss by geographic area, and the like.

A further aspect of the present invention provides a digital television decoder in combination with an apparatus according to a first aspect of the present invention.

A further aspect of the present invention provides a method of monitoring a digital television decoder connected to a network comprising the steps of
a. receiving raw event data from a digital television decoder on a network;
b. generating significant event data in dependence on received raw event data and in dependence on a set of predetermined rules; and
c. storing the significant event data.

A further aspect of the present invention provides a method of monitoring a digital television decoder connected to a network comprising the steps of
a. retrieving raw event data from a digital television decoder on a network;
b. generating significant event data in dependence on received raw event data and in dependence on a set of predetermined rules; and
c. storing the significant event data.

In one embodiment, step a. may involve receiving and retrieving raw event data from a digital television decoder on a network.

In one embodiment, the rules used to generate the significant event data from the raw event data are configurable and may be updated as desired.

The significant event data may be transmitted onwards on generation, or may be stored on command, or may be stored automatically at predetermined intervals.

A method according to the present invention may further comprise the step of analysing the stored significant event data.

In one embodiment, the raw event data is automatically retrieved from the digital television decoder on the network.

The raw event data may be retrieved at predetermined intervals.

In one embodiment, the predetermined rules model a predetermined behaviour of the digital television decoder.

It is envisaged that as an alternative to a digital television decoder in the form of a set top box or similar, a mobile telephone could be used to receive television signals and the apparatus according to the present invention could operate wherein the mobile phone could act as the decoder and carry out the functions of the decoder. Thus, the apparatus would then be able to monitor the mobile phone as part of a network to obtain raw event data from the mobile phone for subsequent collection and analysis. In the event that a mobile phone is use to collect raw event data, the raw event data could also include raw event data relating to the operation of the mobile phone operations distinct from and/or in combination with the receiving of television signals. Thus, not only would the apparatus be able to collect raw event data relating to all interactions and the like in connection with telephone signal transmission, reception and interaction (as previously described with reference to a decoder), the apparatus would also be able to collect and analyse raw event data relating to the operation of some or all of the other functions carried out by the mobile phone, such as telephone call reception/transmission efficiency, text operations, signal reception levels over time and/or geographic location and the like.

Embodiments of the present invention will now be described, by way of example only, and with reference to the accompanying figures, in which:

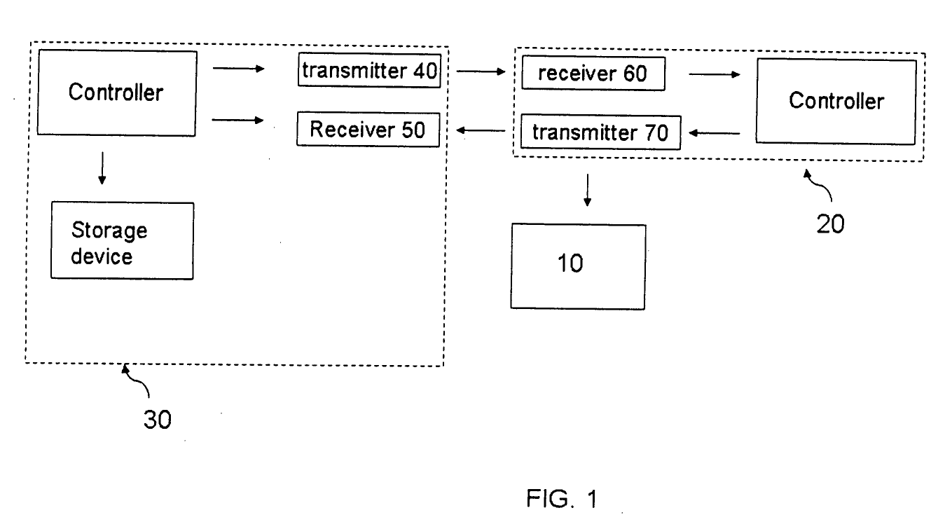

FIG. 1 is a block diagram illustrating a digital television network as known in the prior art;

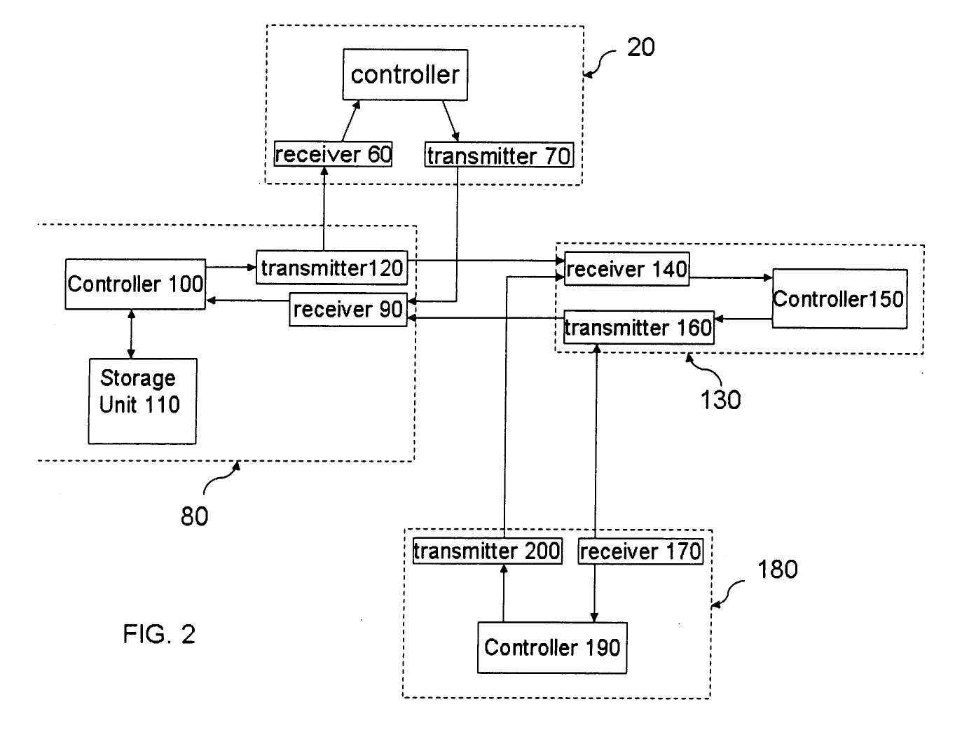

FIG. 2 is a block diagram illustrating a digital television network embodying one aspect of the present invention; and

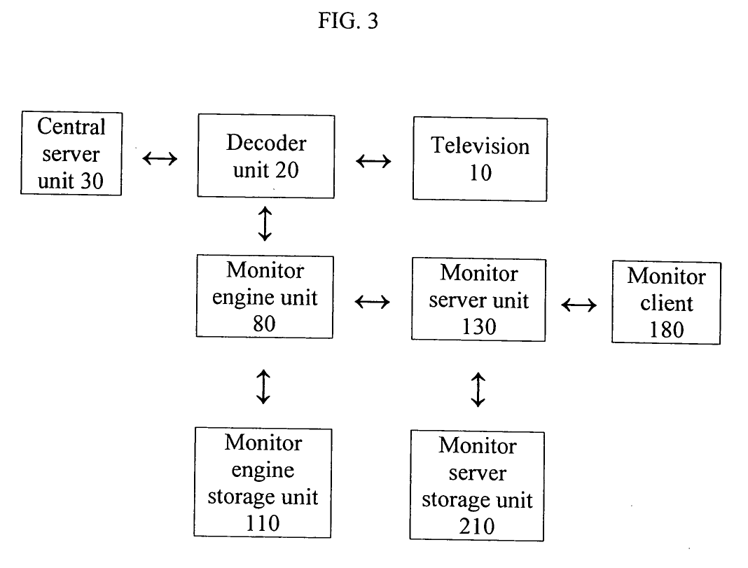

FIG. 3 is a block diagram illustrating a digital television network embodying a further aspect of the present invention; and

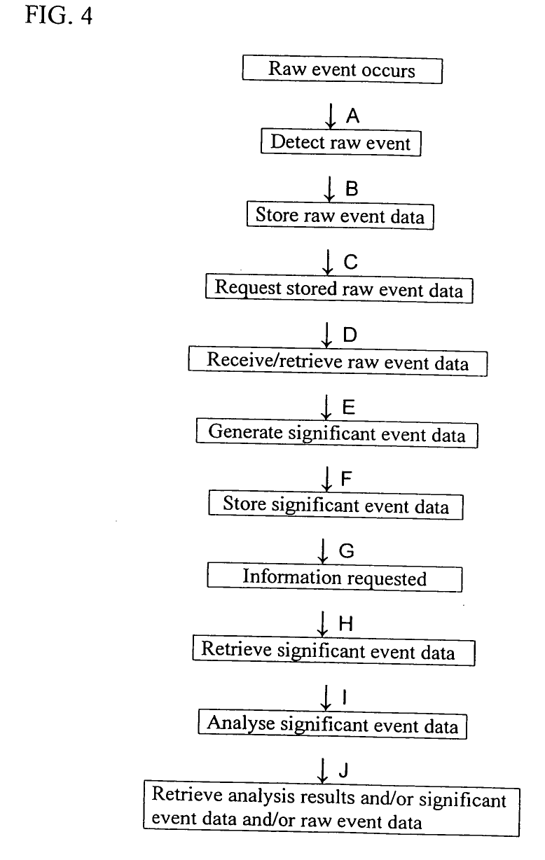

FIG. 4 is a flow chart illustrating a digital television network embodying a further aspect of the present invention.

FIG. 1 illustrates a digital television network as known in the prior art which includes a television unit 10, decoder unit 20 and central server unit 30, as known in the prior art. The central server unit 30 comprises a transmitter 40 and receiver 50 and is operable to transmit a digital television signal from transmitter 40 to a digital decoder unit 20 where the signal is received by digital decoder unit receiver 60 using known techniques. The received signal is then transmitted via digital decoder transmitter 70 to a television unit 10, resulting in a digital television broadcast display on the screen of the television unit using known technology.

FIG. 2 shows the interaction between a digital decoder unit 20 and a digital monitoring system according to a first aspect of the present invention. In a system embodying the present invention, a common path is provided between the digital decoder unit 20 and a monitor engine unit 80. The monitor engine unit 80 comprises a receiver 90 for receiving incoming digital signals, a controller 100 operable to receive the digital signals received by receiver 90 and process the digital signals into usable data. The monitor engine unit 80 may be provided with a storage unit 110, which may or may not be integral with the monitor engine unit 80 (shown as integral in FIG. 2) for storing the data. A transmitter 120 is also provided for the transmission of data in the form of digital signals from the monitor engine unit 80 onwards.

The monitor engine unit 80 is operable to transmit data in the form of digital signals by means of transmitter 120 to a monitor server unit 130. The monitor server unit 130 is provided with a receiver 140 to receive the incoming digital signal information from the monitor engine unit 80 and pass the received signal information to controller 150 for processing. The monitor server unit 130 may also be optionally provided with a storage unit (not shown) for storage of incoming data and also any additional information generated by the monitor server unit 130. A transmitter 160 is provided for onward transmission of information in the form of digital signals to receiver 90 of the monitor engine unit 80 and also to receiver 170 of a client monitor unit 180. The client monitor unit 180 is operable to receive incoming digital signals by means of receiver 170 and process the transmitted information by means of controller 190. The client monitor unit 180 is also provided with a transmitter 200 for transmission of information in the form of digital signals from the client monitor unit in order to maintain a common communication path between the client monitor unit 180 and receiver 140 of the monitor server unit 130.

Referring also to FIGS. 1 and 2, a digital television network embodying a first aspect of the present invention as illustrated in FIG. 3 will now be described. The network comprises a central server unit 30 (as known in the prior art and previously described with reference to FIG. 1) which communicates with a number of digital television decoder units 20 using two way communications links between the transmitter 40 and receiver 50 of the central server unit 30 and the receiver 60 and transmitter 70, respectively, of each decoder unit 20 (for ease of explanation, only one decoder unit 20 is shown in FIG. 3). The decoder unit 20, on operation by a user then transmits the appropriate digital information to the television set 10 for viewing by a user. The decoder unit 20 is in two way communication with a monitor engine unit 80 which is operable to receive and process digital signal information from the decoder unit 20 and to transmit digital signal information to the decoder unit 20. The monitor engine unit 80 is also in communication with the monitor server unit 130 and is operable to receive and transmit digital signal information to and from the monitor server unit 130 accordingly. The monitor engine unit 80 and the monitor server unit 130 are in communication with the monitor engine storage unit 110 and the monitor server storage unit 210, respectively. Although in FIG. 3 the monitor engine storage unit 110 and monitor server storage unit 210 are shown as separate entities, it will be understood that they may be integral with the monitor engine unit 80 and monitor server unit 130, respectively. The monitor server unit 130 is also in two way communication with a monitor client 180. As previously described, a monitor client is a network user who accesses the facilities of the monitor server unit 130. For example, a request for information can be transmitted from the monitor client 180 to the monitor server 130. Once the required information has been identified and/or generated, the requested information can be transmitted from the monitor server 130 in the form of digital signals to the monitor client 180.

FIG. 4 is a flow chart illustrating a digital television network embodying a further aspect of the present invention.

The television 10 is receiving digital broadcast signals from a central server unit 30 by means of a decoder unit 20. The decoder unit 20 is instrumented to provide raw event data i.e. a simple event, for example a user key-press or the like, or a statistic, for example, the amount of free memory available.

At step A of FIG. 4, this raw event data is detected by the decoder unit 20. The raw event data may be detected by logging or polling from within the decoder unit 20 and is optionally stored by the decoder unit 20 (see step B).

On request by the monitor engine unit (80) for the stored raw event data from the decoder unit (20) (see step C), the raw event data is then received/retrieved by the monitor engine unit 80 (see step D) from the decoder unit (20) and is processed by the monitor engine 80 to convert the raw event data to significant event data (see step E). Such significant event data may comprise data relating to a single raw event or a combination or raw events, timings and/or equipment states relating, for example, to the decoder unit operation.

The significant event data may be optionally stored by the monitor engine unit 80 (see step F).

Step G involves a request for information being made by a monitor client 180. It will be understood that there may be more than one monitor client participating in the network, however, only one monitor client is discussed with reference to FIG. 4 for ease of explanation.

Once information has been requested by monitor client 180, the relevant significant event data is retrieved by the monitor server unit 130 (step H) and analysed in response to the request made by the monitor client 180 (see step I). The generated analysis and/or accompanying significant and raw event data is then available for provision by the monitor server 130 to the monitor client 180 (see step J).

Referring to FIGS. 2, 3 and 4, the invention will now explained with reference to an example embodiment in which there is a period of temporary digital broadcast interruption. The raw event data relating to the state transitions of the decoder unit 20 during the period of digital broadcast interruption and subsequent key presses and the like made by a user of the decoder unit 20 is actively logged by the decoder unit 20 as referred to in steps A and B. The decoder unit 20 stores the raw event data locally until retrieval of the raw event data by monitor engine unit 80. The raw event data is transmitted as a digital signal to receiver 90 of the monitor engine unit 80 as described at step D. The raw event data is then translated by the monitor engine unit 80 into significant event data (step E), generated in accordance with certain predetermined rules which model the behaviour of the underlying decoder unit 20. The rules are both configurable and may be reviewed and edited by the monitor server unit 130.

Both the raw event data and the significant event data may be stored by the monitor engine unit 80 within an integral or distinct data storage unit 110 (step F) thereby providing a complete picture of the events both raw and analysed surrounding the interruption to the digital broadcast, including an effects on the behaviour of the decoder unit 20 and the operation of the decoder unit 20 by a user during that period of time.

On request for information from a monitor client 180, for example, relating either directly to that particular broadcast interruption or indirectly to broadcast interruptions generally, the significant event data will be transmitted by means of transmitter 120 of the monitor engine unit 80 to the receiver 140 of the monitor server unit 130 (step H). In cases where the raw event data leading up to the significant event may also be relevant, the appropriate raw event data my also be retrieved from the monitor engine unit 80 by the monitor server unit 130.

Alternatively, the significant event data may already be held on monitor server unit 130 for transmission to monitor client 180 either on request or at a predetermined time. For example, rather than the monitor client 180 triggering the transfer of significant event data from the monitor engine unit 180 to the monitor server 130, transfer of significant event data may be triggered, for example, at predetermined time intervals dependent on the configuration associated with the significant event data in question.

On receipt of the significant, and optionally raw, event data, the monitor server analyses the data received (step I) and provides the analysis, together with any relevant significant and/or raw event data, to the monitor client 180 (step J).

Thus the monitor client 180 is provided with a constant stream of raw event information which is available and can be retrieved at any time, translated into significant event data in dependence on configurable rules modelling the behaviour of the decoder unit 20 and analysed to provide useful information relating to the operation of the decoder unit 20 and operational feedback in relation to the user of the decoder unit 20.

In practical embodiments, HyperText Transfer Protocol (HTTP) and Extensible Markup Language (XML) may be used to transfer data in a digital television network according to the present invention. Definitions of HTTP and XML employed in an embodiment of the present invention are provided below:

HTTP is a standard way for computers to share information. In HTTP, two types of communicating devices exist: user agents (e.g. Browser) and server daemons (e.g. Web server). A user agent makes requests to a daemon application running on another computer. A user agent is a network device that provides and receives HyperText Transfer Protocol (HTTP) information to and from a server daemon application running on another computer.

The user agent and server daemon share information represented in Extensible Markup Language (XML) form. Extensible Markup Language (XML) is a web based data representation form that allows the definition, validation, and interpretation of data between applications and between organizations. A Document Type Definition (DTD) defines the elements that make up the XML used in communication between elements of the system.

The user agent (within the monitor engine unit) can communicate with the server daemon (on the monitor server unit) at regular intervals, and can also send unsolicited information to the server daemon when a significant event occurs. The user agents and server daemon contribute to a database of information representing a view of the current and historical status of the network. HTTP security is provided by using a Secure Socket Layer (SSL) protocol implementation.

Within the monitor engine unit, an XML configuration is retrieved by the user agent on initialisation. The XML defines a list of raw instrumented events and the behaviour defined for the monitor engine unit to deal with events and stimuli within the monitored target platform.

The XML described protocol defines a method with which information for a ME can be read or altered by logically remote users, such as a service provider. HTTP uses the Transmission Control Protocol (TCP) when communicating with its peers. User Datagram Protocol (UDP) is also used where non-guaranteed datagram delivery is acceptable.

The XML defines the events to be managed. Each event has a name, a syntax and an encoding.

The monitor engine unit resides within a target platform and the platform is instrumented to deliver raw event data relating to behaviour of the platform. This data can relate to any measurable operational characteristics of the platform. In addition to this the platform can be interrogated to retrieve status information from components of the monitored target platform.

At certain timed intervals or when particular threshold conditions occur the platform sends groups of raw event data to the monitor engine. The monitor engine separates the grouped data into individual raw events and processes each raw event in turn, in time order at which they occurred. Processing of the raw events involves testing each event against each rule from the XML configuration (rule) file. According to these rules the raw events (or combinations thereof) trigger further actions. These actions can include: changing an internal state of the platform (e.g. process ‘x’ moves to state ‘y’), generating a significant event which then gets sent to the monitor server unit, or generating a secondary raw event (and in this manner complex event sequences can be broken down into more manageable sub-sequences). Raw events are added to an internal buffer and are considered ‘live’ until they are cancelled as a result of a trigger from a rule. Rule triggers may also be used to activate timers.

For example, the pressing of a particular button on the infra-red control device may be a raw event. Combinations and timings of these key presses may constitute a significant event, e.g. if a user presses a particular button 5 times in 30 seconds then this could constitute a ‘user frustration’ significant event which is reported to the monitor server unit. The button presses would then be deleted from the active raw event buffer once the significant event has been reported.

This approach allows for the reception of raw information and the ability to poll different parts of the decoder unit (or set-top box) to monitor their operational state and deliver specific tailored significant event data to the monitor server unit.

Data is received and interrogated to provide live status information and additionally stored in a relational database on the monitor server unit. The monitor server unit provides support for the delivery of data to and from the individual monitor engine units and support for services provided by the monitor client units. These services include the historical analysis of events to provided counts, values and trends within the received data. This information analysis provides a view of the behaviour of the network and use of the equipment monitored.

Monitor client units provide a Graphical User Interface to display live and historical analysis of the data received from the network. The monitor client units communicate with the monitor server unit using a similar HTTP and XML approach to transfer information.

Although aspects of the invention have been described with reference to the embodiments shown in the accompanying drawings, it is to be understood that the invention is not limited to those precise embodiments and that various changes and modifications may be effected without further inventive skill and effort.

1. Apparatus for monitoring a digital television decoder connected to a network comprising a monitor engine and a monitor server wherein the monitor engine is operable to receive raw event data from a digital television decoder connected to a network, generate significant event data in dependence on the received raw event data and in dependence on a set of predetermined rules, and transmit the significant event data to the monitor server which is operable to receive the significant event data from the monitor engine and store the significant event data, the monitor server being operable to retrieve the significant event data on request.

2. Apparatus for monitoring a digital television decoder connected to a network comprising a monitor engine and a monitor server wherein the monitor engine is operable to retrieve raw event data from a digital television decoder connected to a network, generate significant event data in dependence on the received raw event data and in dependence on a set of predetermined rules, and transmit the significant event data to the monitor server which is operable to receive the significant event data from the monitor engine and store the significant event data, the monitor server being operable to retrieve the significant event data on request.

3. Apparatus for monitoring a digital television decoder connected to a network comprising a monitor engine and a monitor server wherein the monitor engine is operable to receive and retrieve raw event data from a digital television decoder connected to a network, generate significant event data in dependence on the received raw event data and in dependence on a set of predetermined rules, and transmit the significant event data to the monitor server which is operable to receive the significant event data from the monitor engine and store the significant event data, the monitor server being operable to retrieve the significant event data on request.

4. Apparatus according to claim 1, wherein the raw event data is written to local storage prior to transmission from the monitor engine.

5. Apparatus according to claim 1, wherein the monitor engine is further operable to automatically retrieve the raw event data from a digital television decoder connected to a network.

6. Apparatus according to claim 1, wherein the monitor engine is further operable to retrieve raw event data from a digital television decoder connected to a network at predetermined time intervals.

7. Apparatus according to claim 1, wherein the predetermined rules model a predetermined behaviour of the digital television decoder.

8. Apparatus according to claim 1, wherein the predetermined rules are configurable by the monitor server.

9. Apparatus according to claim 1, wherein the monitor engine is further operable to store the significant event data automatically.

10. Apparatus according to claim 9, wherein the monitor engine is further operable to store the significant event data at predetermined time intervals.

11. Apparatus according to claim 10, wherein the monitor server is operable to automatically store the significant event data at predetermined intervals.

12. Apparatus according to claim 10, wherein the monitor server is further operable to analyse the stored significant event data.

13. Apparatus according to claim 12 wherein the monitor server is further operable to provide analysis results on request.

14. Apparatus according to claim 1, wherein the monitor server is further operable to provide significant event data on request.

15. Apparatus according to claim 1 in combination with a digital television decoder.

16. A method of monitoring a digital television decoder connected to a network comprising the steps of
a. receiving raw event data from a digital television decoder connected to a network;
b. generating significant event data in dependence on received raw event data and in dependence on a set of predetermined rules; and
c. storing the significant event data.

17. A method of monitoring a digital television decoder connected to a network comprising the steps of
a. retrieving raw event data from a digital television decoder connected to a network;
b. generating significant event data in dependence on received raw event data and in dependence on a set of predetermined rules; and
c. storing the significant event data.

18. A method according to claim 17 wherein the step of retrieving raw event data from a digital television decoder connected to a network further comprises receiving raw event data from a digital television decoder connected to a network.

19. A method according to claim 16, wherein the significant event data is stored automatically at predetermined intervals.

20. A method according to claim 16, further comprising the step of analysing the stored significant event data.

21. A method according to any one of claim 16, wherein the raw event data is automatically retrieved from the digital television decoder on the network.

22. A method according to claim 16, wherein the raw event data is retrieved at predetermined intervals.

23. A method according to claim 16, wherein the predetermined rules model a predetermined behaviour of the digital television decoder.

24-25. (canceled)
